(19) United States
(12) Patent Application Publication
(10) Pub. No.: US 2006/0153630 A1
(43) Pub. Date: Jul. 13, 2006

(54) Ring mechanism with collapsible ring members

(75) Inventor: Hung Yu Cheng, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 11/175,696

(22) Filed: Jul. 6, 2005

Related U.S. Application Data
(60) Provisional application No. 60/642,963, filed on Jan. 11, 2005.

(51) Int. Cl. B42F 13/00

(52) U.S. Cl. 402/79

(57) ABSTRACT

A ring binder mechanism for retaining loose-leaf pages includes a housing, two hinge plate, and rings. The housing supports the hinge plates for pivoting motion relative to the housing. Ring members of the rings are resiliently clamped to the hinge plates for conjoint movement with the pivoting hinge plates to move between an open position in which pages may be added or removed from the rings and a closed position in which pages are retained by the rings. The ring members are also pivotable about an axis generally perpendicular to a longitudinal axis of the housing relative to the hinge plates between an upright configuration in which pages can be retained on the ring members and a collapsed configuration in which the ring mechanism can be stored or shipped.

### CROSS REFERENCE TO RELATED APPLICATION

This application claims the benefit of U.S. Provisional Application No. 60/642,963, filed Jan. 11, 2005, and entitled Ring Mechanism with Collapsible Ring Members, the entire disclosure of which is hereby incorporated by reference.

### BACKGROUND OF THE INVENTION

This invention relates to a ring binder mechanism for retaining loose-leaf pages, and in particular to a mechanism with ring members that are moveable between an upright configuration in which pages can be retained on the ring members and a collapsed configuration in which the ring mechanism can be stored.

A ring binder mechanism retains loose-leaf pages, such as hole-punched pages, in a file or notebook. It has rings formed by two ring members for retaining the pages. The rings may be selectively opened to add or remove pages to the rings or closed to retain pages on the rings while allowing the pages to move along the rings. The ring members of each ring rigidly mount on two adjacent hinge plates. The hinge plates loosely join together about a pivot axis for pivoting movement within an elongate housing. The housing holds the hinge plates so they may pivot relative to the housing and move the ring members between an open position and a closed position. The undeformed housing is narrower than the joined hinge plates when the hinge plates are in a coplanar position (180 degrees). So as the hinge plates pivot through this position, they deform the resilient housing and cause a spring force in the housing that urges the hinge plates to pivot away from the coplanar position, moving the ring members to either their open or closed position.

A drawback to the traditional ring binder mechanism relates to commercialization of the mechanism, including shipping, handling, and storing of the mechanism. An individual ring mechanism can take up a large amount of space when packed for shipping or storing. This is because of the rings projecting from the housing of the mechanism. Large space gaps exist between the rings of each mechanism, leaving large amounts of room unused during shipping and storing of multiple mechanisms. As a result, packing the ring mechanisms can be inefficient, and shipping and handling costs may be high.

In response to this drawback, manufacturers of ring binder mechanisms typically pack the mechanisms in alternating directions to utilize the space between the rings. The rings of one mechanism are positioned between the rings of an adjacent mechanism. But even this packing technique leaves large amounts of space between the rings of each mechanism unused. Similar drawbacks apply when packing notebooks and files incorporating traditional ring mechanisms. While the notebooks and files can be packed in alternating directions to improve shipping or storing efficiency, the size and shape of the rings still leave large amounts of space unused.

Attempts have been made to develop ring binder mechanisms with collapsible ring members to eliminate the space gaps between ring members when the mechanisms are stored or shipped. An example of a ring mechanism with collapsible ring members is shown in U.S. Pat. No. 5,642,954 (Hudspith). In the known mechanisms, ring members are typically held in an upright position to retain pages by a pin connection. But often times this connection is permanent or difficult to access. Additionally, pin connections in general may be complex and difficult to manufacture, and production costs for collapsible ring mechanisms with these connections may be high.

Accordingly, it would be desirable to produce a cost-efficient ring binder mechanism with collapsible ring members that are easy to move between an upright position and a collapsed position and that securely stay in the upright position during use.

### SUMMARY OF THE INVENTION

A ring binder mechanism for retaining loose-leaf pages generally comprises a housing for supporting hinge plates for pivoting motion relative to the housing. The mechanism also includes rings for holding the loose-leaf pages. Each ring includes a first ring member and a second ring member. The first ring member is moveable with the pivoting motion of a first of the hinge plates relative to the second ring member between a closed position and an open position. In the closed position, the two ring members form a substantially continuous, closed loop for allowing loose-leaf pages retained by the rings to be moved along the rings from one ring member to the other. In the open position, the two ring members form a discontinuous, open loop for adding or removing loose-leaf pages from the rings. The first ring member of each ring is resiliently clamped to the first hinge plate. The first and second ring members of each ring are moveable relative to the hinge plates between an upright configuration and a collapsed configuration.

In another aspect, the ring mechanism generally comprises a housing supporting hinge plates for pivoting motion relative to the housing. The mechanism also includes rings for holding the loose-leaf pages. Each ring includes a first ring member and a second ring member. The first ring member is moveable with the pivoting motion of a first of the hinge plates relative to the second ring member between a closed position and an open position. In the closed position, the two ring members form a substantially continuous, closed loop for allowing loose-leaf pages retained by the rings to be moved along the rings from one ring member to the other. In the open position, the two ring members form a discontinuous, open loop for adding or removing loose-leaf pages from the rings. The first and second ring members each have a mated end. The mated end of the first ring member has a tongue and the mated end of the second ring member has a groove for receiving the tongue of the first ring member into operative connection with the groove. The tongue and groove each have a length substantially aligned with the lengths of the first and second ring members.

Other features of the invention will be in part apparent and in part pointed out hereinafter.

### BRIEF DESCRIPTION OF THE DRAWINGS

FIG. 1 is a perspective of a notebook incorporating a ring binder mechanism according to a first embodiment of the invention;

FIG. 2 is an exploded perspective of the ring mechanism;

FIG. 3 is a perspective of a pair of ring members of a ring of the ring mechanism;

FIG. 4 is a bottom side perspective of the ring mechanism at a first, operating configuration with the ring members at a closed position;

FIG. 5 is a bottom side perspective similar to FIG. 4 with the ring members at an open position;

FIG. 6 is a top side perspective of the ring mechanism at the first, operating configuration with the ring members at the closed position;

FIG. 7 is a top side perspective similar to FIG. 6 with the ring members at the open position;

FIG. 8 is a cross section taken in the plane of line 8-8 of FIG. 6;

FIG. 9 is the perspective of FIG. 6 with parts of the mechanism removed to show internal construction;

FIG. 10 is an enlarged and fragmentary perspective taken as indicated in FIG. 9 and showing a tongue and groove connection between ends of a pair of interengaging ring members mounted on hinge plates;

FIG. 11 is a top side perspective of the ring mechanism at a second, collapsed configuration;

FIG. 12 a bottom side perspective thereof;

FIG. 13 is an exploded perspective of a ring binder mechanism according to a second embodiment of the invention;

FIG. 14 is a top side perspective of the ring mechanism of FIG. 13 with parts removed to show internal construction and with the mechanism at the first, operating configuration with ring members at the closed position;

FIG. 15 is an enlarged and fragmentary perspective taken as indicated in FIG. 14 and showing a tongue and groove connection between ends of a pair of interengaging ring members mounted on hinge plates;

FIG. 16 is a top side perspective of the ring binder mechanism of FIG. 13 at the second, collapsed configuration with pairs of collapsible ring members folded in one direction;

FIG. 17 is a perspective similar to FIG. 16 with the pairs of ring members folded in an opposite direction;

FIG. 18 is an exploded perspective of a ring binder mechanism according to a third embodiment of the invention;

FIG. 19 is a top side perspective of the ring mechanism of FIG. 18 with parts removed to show internal construction and with the mechanism at the first, operating configuration with ring members in the closed position;

FIG. 20 is an enlarged and fragmentary perspective taken as indicated in FIG. 19 and showing a tongue and groove connection between ends of a pair of interengaging ring members mounted on hinge plates; and

FIG. 21 is an enlarged and fragmentary perspective showing the ends of the pair of ring members when the mechanism is at the second, collapsed configuration.

Corresponding reference characters indicate corresponding parts throughout the views of the drawings.

### DETAILED DESCRIPTION OF THE INVENTION

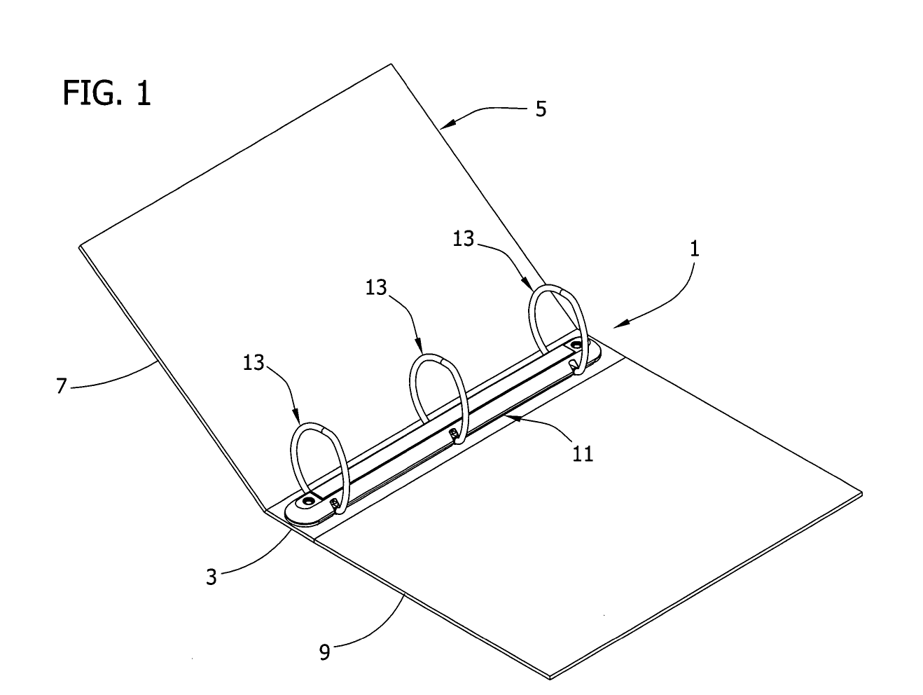

Referring now to the drawings, FIGS. 1-12 show a ring binder mechanism according to a first embodiment of the invention. The mechanism is used to retain loose-leaf pages, such as hole-punched papers, in a file or notebook. The mechanism is designated generally by reference numeral 1 and is shown in FIG. 1 mounted on a spine 3 of a notebook. The notebook is designated generally by reference numeral 5 and has a front cover 7 and a back cover 9 hingedly attached to the spine 3. The front and back covers 7, 9 move to selectively cover or expose loose-leaf pages (not shown) retained by the mechanism 1. Ring binder mechanisms mounted on surfaces other than a notebook do not depart from the scope of this invention.

The ring mechanism 1 includes a housing (designated generally by reference numeral 11) and three rings (each designated generally by reference numeral 13). As will be described, the housing 11 supports the rings 13 for movement between a closed position in which pages are retained by the mechanism 1 and an open position in which pages may be loaded or removed from the mechanism. The housing 11 also supports the rings 13 for movement between a first, operating configuration in which the rings can move between their closed and open positions and a second, collapsed configuration in which the mechanism 1 can be efficiently packed for shipping or storing. A ring mechanism may have more than or fewer than three rings within the scope of this invention.

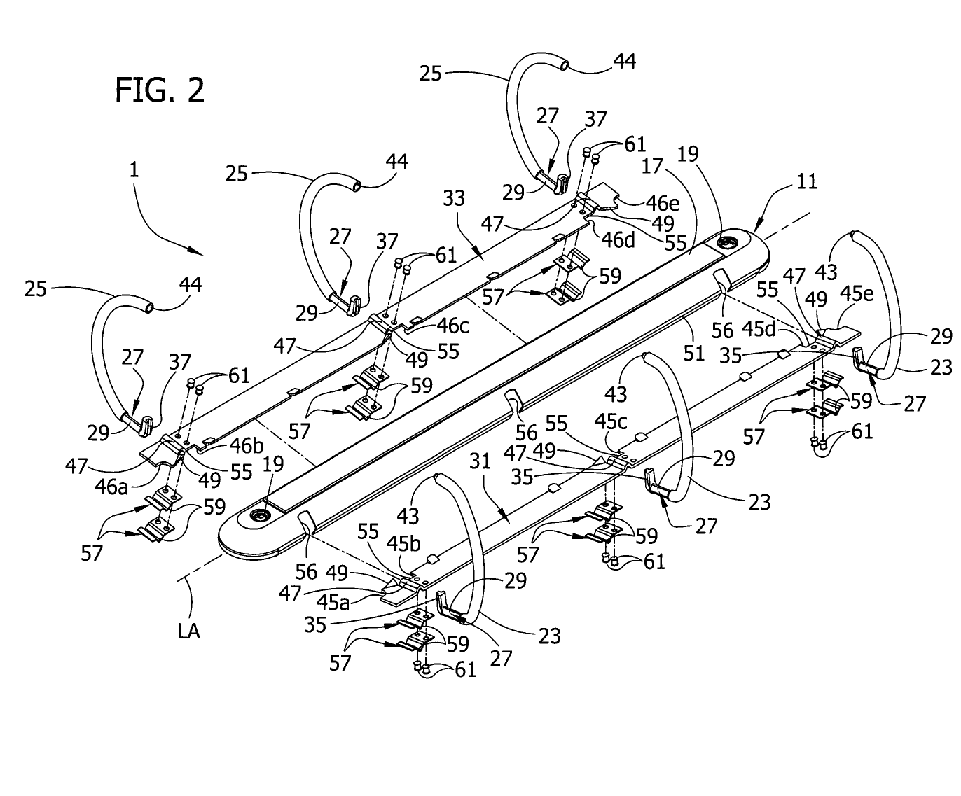

As shown in FIG. 2, the housing 11 of the mechanism 1 is elongate with generally parallel longitudinal sides, rounded ends, and a uniform, generally arch-shaped cross section having a plateau 17 at its center. A longitudinal axis of the housing 11 is indicated by reference numeral LA. Two mounting post openings are each designated by reference numeral 19 and are located in the plateau 17 toward longitudinal ends of the plateau. Each mounting post opening 19 receives and attaches a mounting post (not shown) to the mechanism 1 to secure it to the spine 3 of the notebook 5 as is common in the art (FIG. 1). Mechanisms having housings of other shapes, including irregular or asymmetrical shapes, or housings that are integral with a file or notebook do not depart from the scope of this invention.

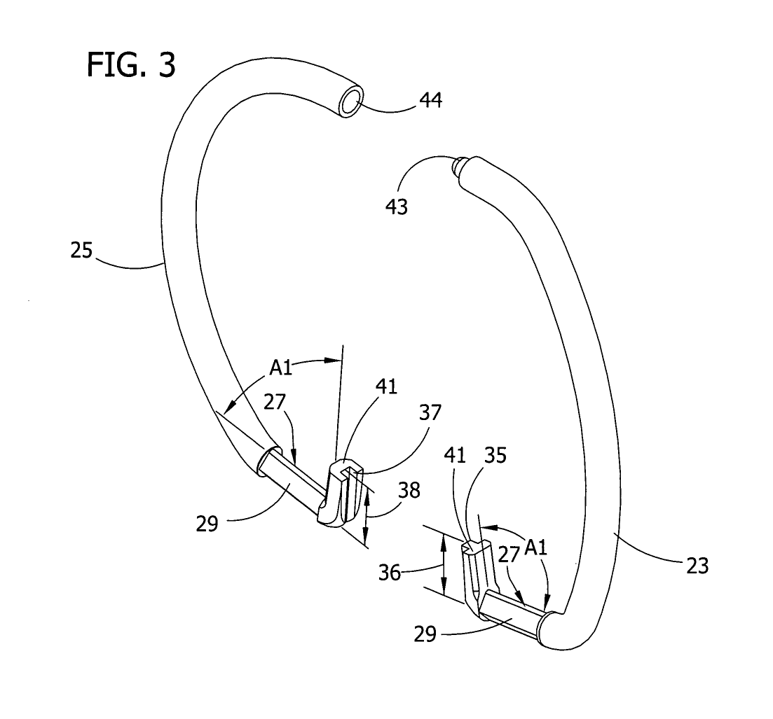

The three rings 13 of the mechanism 1 are substantially similar. Ring 13 at the left end of mechanism 1 will be described with it understood that a description of the center ring 13 and the ring 13 at the right end of mechanism 1 is the same. As shown in FIGS. 2 and 3, ring 13 includes first and second ring members 23, 25 that form the ring. A lower, L-shaped end segment of each ring member 23, 25 is indicated generally by reference numeral 27 and is of reduced diameter compared to the rest of the ring member. The end segment 27 includes a portion 29 with a diamond-shaped cross section used to mount the respective ring member 23, 25 under one of two hinge plates, which are indicated generally by reference numerals 31, 33 (FIG. 2) and will be described shortly.

Referring to FIG. 3, the end segment 27 of the first ring member 23 also includes a tongue 35 and the end segment of the second ring member 25 also includes a groove 37. The tongue 35 of the first ring member 23 and the groove 37 of the second ring member 25 each extend generally upward from the diamond-shaped portion 29 of their respective end segment 27 and terminate at a respective end 41 (FIG. 3). The extending tongue 35 and groove 37 each form an angle A1 with their respective diamond-shaped portion 29 that is slightly greater than 90 degrees. The tongue 35 and groove 37 also each have a length indicated by reference numerals 36 and 38, respectively. The length 36 of the tongue 35 and the length 38 of the groove 37 are similar in dimension and are both generally aligned with the lengthwise extension of the ring members 23, 25 (i.e., a plane that contains a centerline of the respective ring member). It will be understood that the tongue 35 and groove 37 can be associated with either of the first or second ring members 23, 25 within the scope of the present invention.

Referring now to FIG. 2, first and second hinge plates 31, 33 supporting the ring members 23, 25 are each elongate and generally flat. Each hinge plate 31, 33 includes five cutouts along its inner longitudinal edge margin. Cutouts in the first hinge plate 31 are designated by reference numerals 45a-e, and cutouts in the second hinge plate 33 are designated by reference numerals 46a-e. Cutouts 45a, 45e and 46a, 46e are located at opposite longitudinal ends of the respective first and second hinge plates 31, 33, and cutouts 45b-d and 46b-d are spaced inward from cutouts 45a, 45e and 46a, 46e, respectively.

Inverted channels, each designated by reference numeral 47, and stoppers, each designated by reference numeral 49, are also formed in the hinge plates 31, 33 adjacent each of the inward cutouts 45b-d, 46b-d. Each channel 47 is substantially the same, and each stopper is substantially the same. Therefore, only channel 47 and stopper 49 at inward cutout 45b will be described with it understood that a description of the channels and stoppers at cutouts 45c-d and 46b-d is the same.

Inverted channel 47 is generally triangular (or “half diamond”) in shape and is formed at inward cutout 45b adjacent a forward end of the cutout (left side of the cutout in FIG. 2). The channel 47 extends the full width of hinge plate 31 from the outer longitudinal edge margin of the plate to an interior edge margin 55 of the cutout 45b. Stopper 49 is formed adjacent the inverted channel 47, along the inner longitudinal edge margin of hinge plate 31 and at a forward inner edge margin corner of the cutout 45b. The location of the channel 47 and stopper 49 can be varied without departing from the scope of the invention. It is envisioned that each inverted channel 47 and stopper 49 of ring mechanism 1 are formed by deforming a part of the respective hinge plate 31 or 33 upward. But it is understood that they could be formed differently without changing the invention.

Spring mounting plates are each designated generally by reference numeral 57 and are used to hold the ring members 23, 25 against the hinge plates 31, 33. This will be described in more detail hereinafter. Each mounting plate 57 is substantially identical and has a thin and elongate shape. Each includes a triangular (or “half diamond”) channel 59 extending transversely from one longitudinal edge of the mounting plate 57 to the other. It is envisioned that the channel 59 of each mounting plate 57 is formed by bending or folding the mounting plate, but a mechanism having spring mounting plates with channels formed differently does not depart from the scope of the invention.

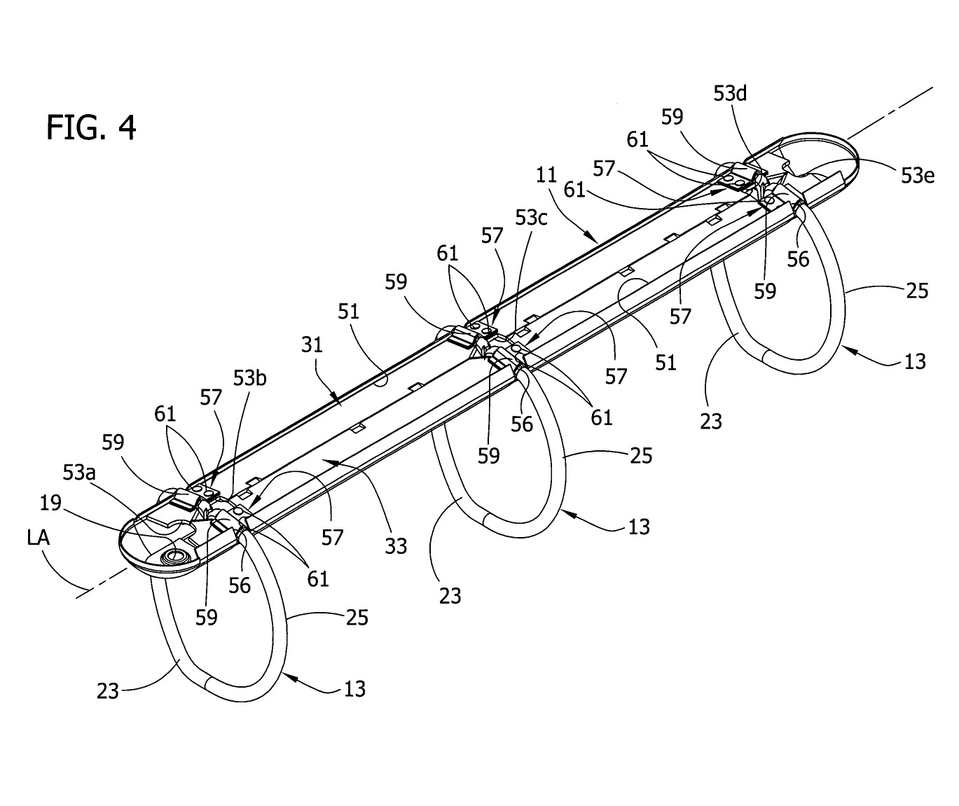

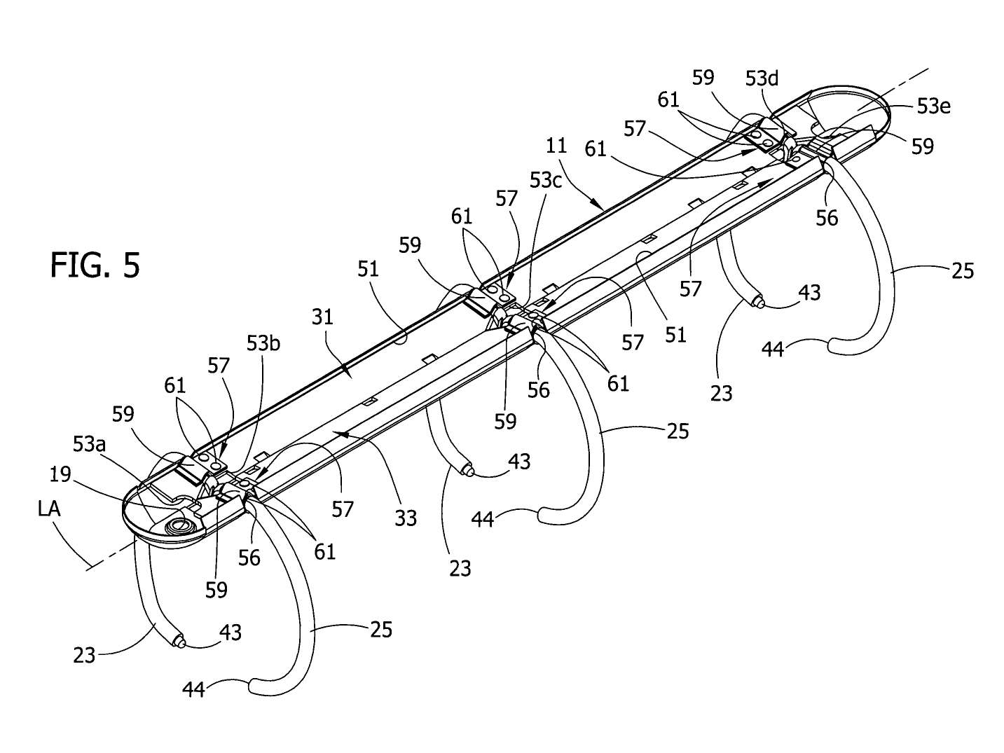

The assembled ring binder mechanism 1 will now be described with reference to FIGS. 4-7. As best shown in FIGS. 4 and 5, the two hinge plates 31, 33 interconnect along their inner longitudinal edge margins to form a central hinge having a pivot axis. The housing 11 retains the two hinge plates 31, 33 together under the housing behind a pair of longitudinally extending bent rims that are each indicated by reference numeral 51. Outer longitudinal edge margins of the hinge plates 31, 33 are loosely received behind the bent rims 51, and a spring force of the housing 11 loosely holds the hinge plates 31, 33 together at their pivot axis behind the rims 51. The hinge plates 31, 33 pivot within the rims 51 and move their pivot axis upward and downward relative to the housing 11. The mounting of the hinge plates 31, 33 is essentially conventional in the illustrated embodiments.

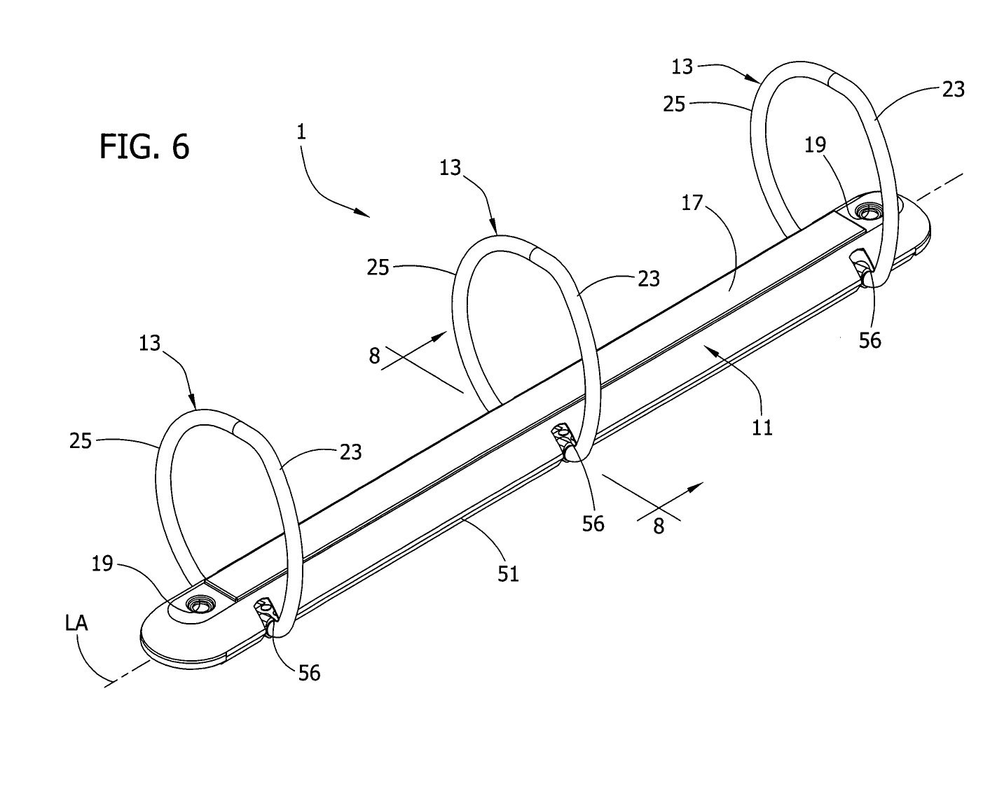

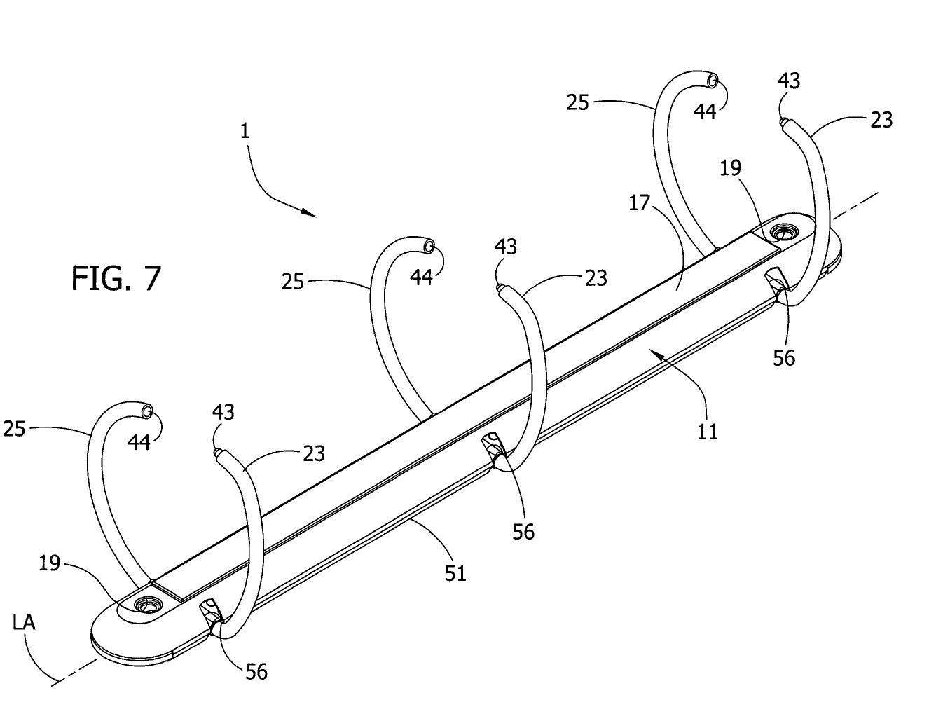

Cutouts 45a-e and 46a-e in hinge plate 31 and 33, respectively (FIG. 2), align to form openings 53a-e in the interconnected hinge plates, with the pivot axis of the plates extending through each opening. Ring members 23, 25 mount under the interconnected hinge plates 31, 33 and extend above the housing through openings 56 along longitudinal sides of the housing 11 (FIGS. 6 and 7, openings on only one side of the housing are visible). End openings 53a, 53e of the interconnected plates 31, 33 accommodate the mounting posts (not shown) attached to the housing 11 through the hinge plates as is known in the art to allow the hinge plates to pivot without contacting the posts.

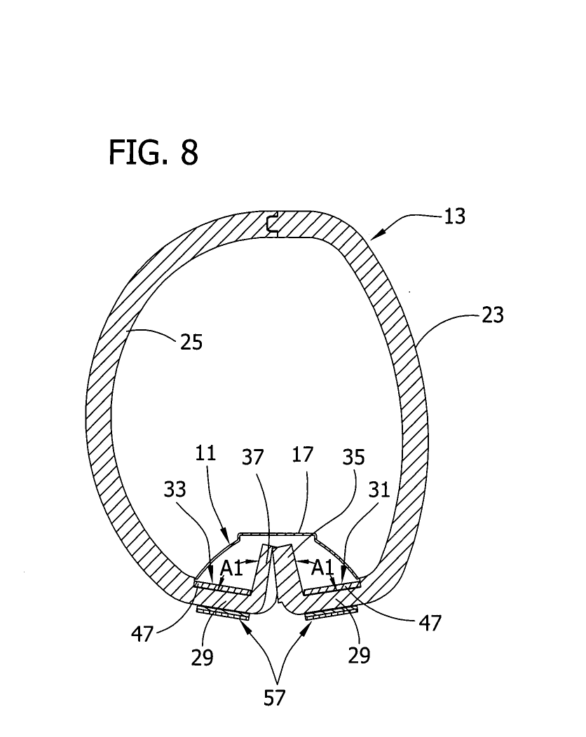

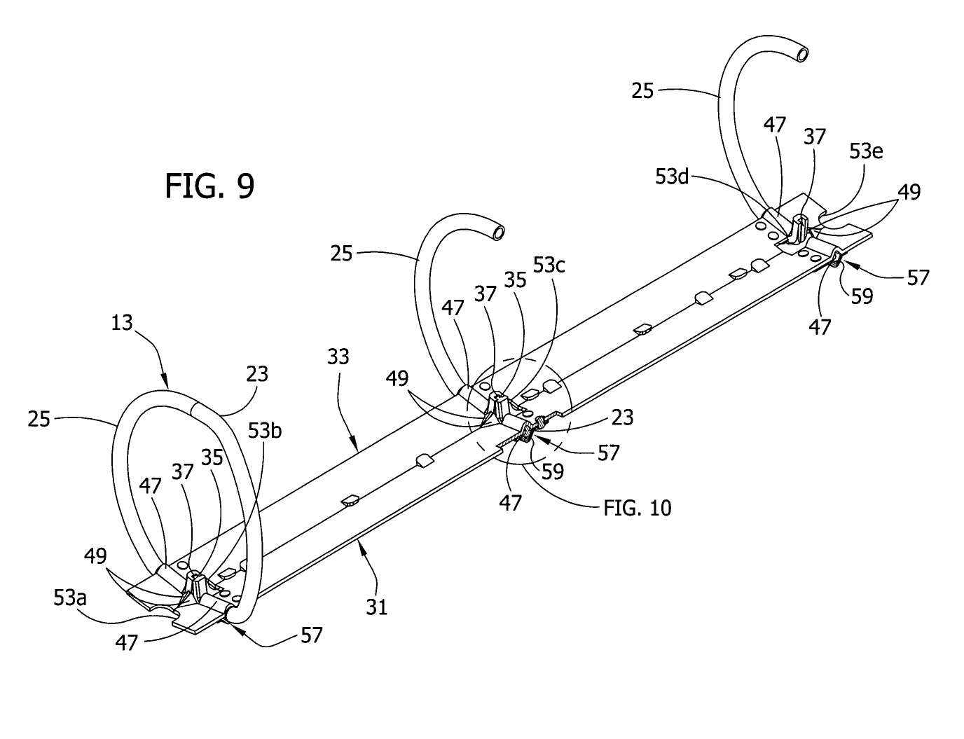

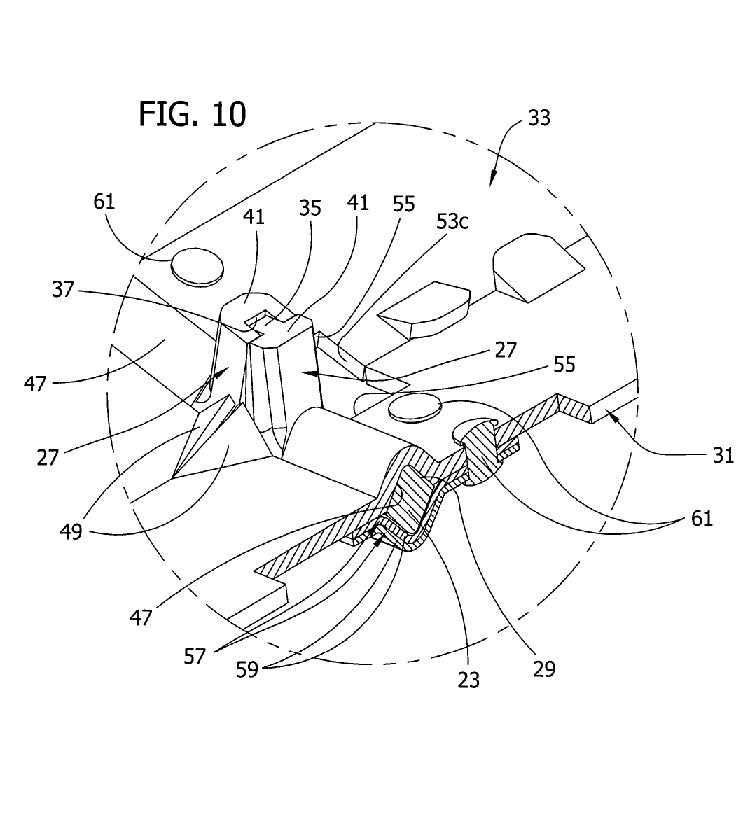

Referring to FIGS. 8-10, ring members 23, 25 are shown mounted under the hinge plates 31, 33 adjacent openings 53b-d. Inward openings 53b-d, located between end openings 53a, 53e, accommodate the tongue 35 and groove 37 (the tongue and groove are not fully visible in the openings) of the respective first and second ring members 23, 25. The ring members 23, 25 of center ring 13 mounted at inward opening 53c will be described with particular reference to FIG. 10 with it understood that the description also applies to the ring members 23, 25 of end rings 13 mounted adjacent openings 53b and 53d (in FIG. 9, the ring member 23 of center ring 13 is mostly broken away). The diamond-shaped portions 29 of the first and second ring members 23, 25 fit partially within and conform in shape to respective inverted channels 47 under respective hinge plates 31 and 33. Two of spring mounting plates 57 are used hold each ring member 23, 25 against bottom surfaces of respective hinge plates 31 and 33 within channels 47. The tongue 35 of the first ring member 23 and the groove 37 of the second ring member 25 extend from the respective diamond-shaped portions 29 into opening 53c where the groove 37 receives the tongue 35. Because of respective angles A1 (FIG. 3) between tongue 35 and its diamond-shaped portion 29 and between groove 37 and its diamond-shaped portion 29, the tongue and groove are each oriented askew to a plane containing respective hinge plates 31, 33. Inverted channel 47 and stoppers 49 are located, and opening 53c is sized, to allow the connected tongue and groove to move relative to the hinge plates 31, 33 when the ring members 23, 25 rotate between the operating (upright) configuration and the collapsed configuration.

FIG. 10 shows mounting plates 57 holding ring member 23 of center ring 13 against hinge plate 31. Rivets 61 connect the mounting plates 57 to hinge plate 31 in stacked, overlapping fashion. The two mounting plates 57 lie flush together, with the surfaces on opposite sides of channel 59 of the underlying plate oriented flush against the bottom surface of hinge plate 31. The overlapped mounting plate channels 59 face the inverted channel 47 of hinge plate 31 and form a diamond-shaped channel passage that closely conforms to the diamond-shaped portion 29 of ring member 23. It will be appreciated that the shape of the passage formed by channel 47 and channel 59 and the shape of the diamond-shaped portion 29 correspond to each other and tend to lock together when ring member 23 is in its upright, operating configuration. Other shapes can be used, and those which produce a locking interconnection at the upright configuration are preferred. While in the illustrated embodiment each of the mounting plates 57 are separate from the hinge plates 31, 33, a mechanism in which mounting plates are integral with hinge plates would not alter the scope of the invention. More than two spring mounting plates may be used to hold each ring member against respective hinge plates without departing from the scope of this invention. A later embodiment also shows one spring mounting plate used to hold each ring member against respective hinge plates. In addition, more or fewer than two rivets may be used to connect mounting plates to hinge plates without departing from the scope of this invention. Furthermore, different connections may be used to secure spring mounting plates to hinge plates within the scope of the invention.

As also shown in FIG. 10, the rivets 61 connect mounting plates 57 to hinge plate 31 at longitudinal ends of the mounting plates. The mounting plates 57 are thus held in cantilevered position with their unconnected ends free to resiliently move toward and away from the bottom surface of hinge plate 31. This resiliently clamps ring member 23 at its diamond-shaped portion 29 between the spring mounting plates 57 and the hinge plate 31. The diamond-shaped portion 29 can still be rotated within the diamond-shaped passage under force of an operator as will be described. It is understood that all ring members 23, 25 of mechanism 1 are similarly resiliently clamped against hinge plates 31, 33 by mounting plates 57.

Operation of the ring mechanism 1 to open and close ring members 23, 25 of rings 13 will now be described. As is known, the undeformed housing 11 of mechanism 1 is slightly narrower than the joined hinge plates 31, 33 when the hinge plates are in the coplanar position. When the hinge plates 31, 33 pivot through this position, they deform the resilient housing 11 and create a spring force in the housing that urges the hinge plates 31, 33 to pivot away from the coplanar position either toward the housing 11 or away from the housing.

Referring to FIGS. 4 and 6, when the ring members 23, 25 are in the closed position, the hinge plates 31, 33 are hinged generally downward and away from the housing 11. The interengaging free ends 43, 44 (FIG. 2) of the respective first and second ring members 23, 25 of each ring 13 are together, and the closed ring members form a substantially continuous, closed, D-shaped loop for retaining the loose-leaf pages (not shown). The spring force of the housing 11 resists hinge plate movement tending to open the ring members 23, 25, and the free ends 43, 44 of ring members 23, 25 are clamped together.

The ring members 23, 25 are opened by pulling the free ends 43, 44 of ring members 23, 25 away from each other. This pivots the hinge plates 31, 33 upward, toward the housing 11, and through the co-planar position. The ring members 23, 25 now form a discontinuous, open loop for adding or removing loose-leaf pages (not shown) from the ring members. The housing spring force resists hinge plate movement tending to close the ring members 23, 25. FIGS. 5 and 7 show ring mechanism 1 with ring members 23, 25 in this open position.

The open ring members 23, 25 are returned to their closed position by pushing the ring members 23, 25 together. This pivots the hinge plates 31, 33 downward and through the coplanar position and moves the free ends 43, 44 of respective ring members 23, 25 together. The spring force of the housing 11 again resists hinge plate movement tending to open the ring members 23, 25 and clamps the ring members closed.

It will be understood that when the first and second ring members 23, 25 pivot with the hinge plates 31, 33 to open and close, the tongue 35 and groove 37 rock back and forth while remaining connected and strongly resist forces that would tend to misalign respective interengaging free ends 43, 44 of the first and second ring members 23, 25. Sides of the L-shaped end segments 27 of ring members 23, 25 that are opposite the tongue and groove connection abut a respective interior edge margin 55 of the opening 53c at the channel 47 (FIG. 10). This holds the tongue 35 and groove 37 together under the spring force of the housing 11 while still allowing the rocking movement between the tongue 35 and groove 37 when the ring members 23, 25 open and close. The ring members 23, 25, and specifically the diamond-shaped portions 29 of the ring members, do not move relative to the hinge plates 31, 33 during this movement. Instead, the L-shaped end segments 27 of the paired ring members 23, 25 are fixedly held in contact with the hinge plates 31, 33 and with each other. In addition, the angles A1 (FIG. 3) of the tongue 35 and groove 37 relative to their respective diamond-shaped portion 29 help hold respective lengths 36, 38 of the tongue 35 and groove 37 in connection during operation. Specifically, the relative angles A1 force upper sections of the tongue 35 and groove 37 together while hinge plates 31, 33 resist lower sections of the tongue and groove moving apart. This creates a small tension in the connection that stabilizes it when the ring members 23, 25 move between the closed and open positions and when they move between the operating and collapsed configurations as will be described (i.e., it prevents the tongue 35 from sliding out of the groove 37).

The ring mechanism 1 is further moveable between the operating configuration just described and the collapsed configuration, as will now be described. It is understood that the ring members 23, 25 can be in either their closed position or their open position of the operating configuration and still move between the operating configuration and collapsed configuration.

FIGS. 1 and 4-10 show the ring mechanism 1 in the operating (upright) configuration. The ring members 23, 25 of each ring 13 are upright, and a plane containing the centerline of each respective ring member 23, 25 is oriented generally transverse to the longitudinal axis LA of the housing 11. As best shown in FIG. 9, the connected tongues 35 and grooves 37 are generally vertical and extend through inward openings 53b-d of the hinge plates 31, 33. Forward sides (i.e., sides facing left in FIG. 9) of the tongue and groove connections at inward openings 53b and 53c and a rearward side (i.e., a side facing right in FIG. 9) of the connection at inward opening 53e abut respective stoppers 49 of the hinge plates 31, 33, blocking the ring members 23, 25 against collapsible rotation in these directions. The ring members 31, 33 of each ring 13 of this embodiment can therefore only move to the collapsed configuration in one direction away from the stoppers.

An operator moves the ring members 23, 25 toward the collapsed configuration by rotating the ring members 23, 25 about an axis transverse to the longitudinal axis LA of the housing 11, away from respective stoppers 49. The corners of the diamond-shaped portions 29 rotate out of respective elbows of the diamond-shaped passages formed by the channels 47 in the hinge plates 31, 33 and mounting plate channels 59. This cams the mounting plates 57 and deflects their free ends away from the bottom surfaces of the hinge plates 31, 33. The diamond-shaped portions 29 rotate almost 90 degrees and move different corners of the diamond-shaped portions into close fit with subsequent elbows of the diamond-shaped passages. The deflected free ends of the mounting plates 57 resiliently move back toward the bottom surfaces of the hinge plates 31, 33 and again (by compression) resiliently hold the ring members 23, 25 in the collapsed configuration against further rotation. The tongue and groove connections of the ring members 23, 25 have also rotated almost 90 degrees within respective inward openings 53b-d, and the ring members have correspondingly rotated into contact with the housing 11. The thickness of the housing 11 limits the range of ring member rotation, but the range is still sufficient to efficiently fold the ring members for storing or shipping the ring mechanism.

It is understood that either one or both of ring members 23 and/or 25 of each ring 13 can be rotated to collapse the ring. For example, the operator can grasp both the first and second ring members 23, 25 of a ring 13 to simultaneously move both ring members (and the ring) to the collapsed configuration. Alternatively, the operator can grasp just one ring member 23 or 25 and simultaneously move both ring members (and ring 13) to the collapsed configuration because of the tongue and groove connection holding the ring members together. Here, rotating one ring member 23 or 25 to the collapsed configuration conjointly rotates the other ring member 23 or 25.

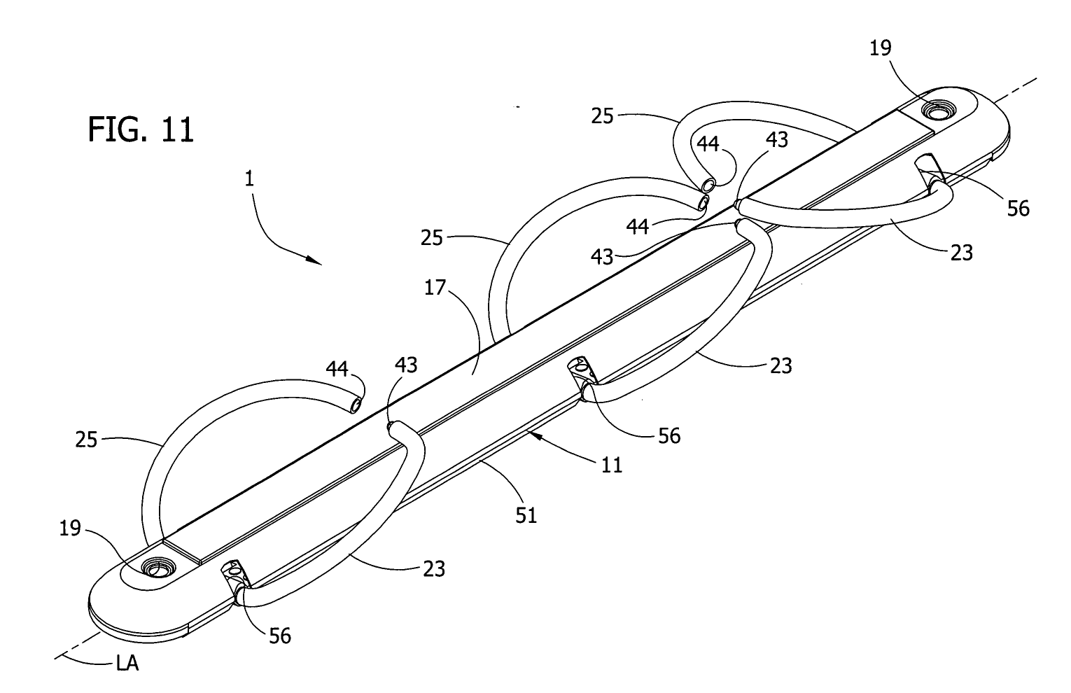

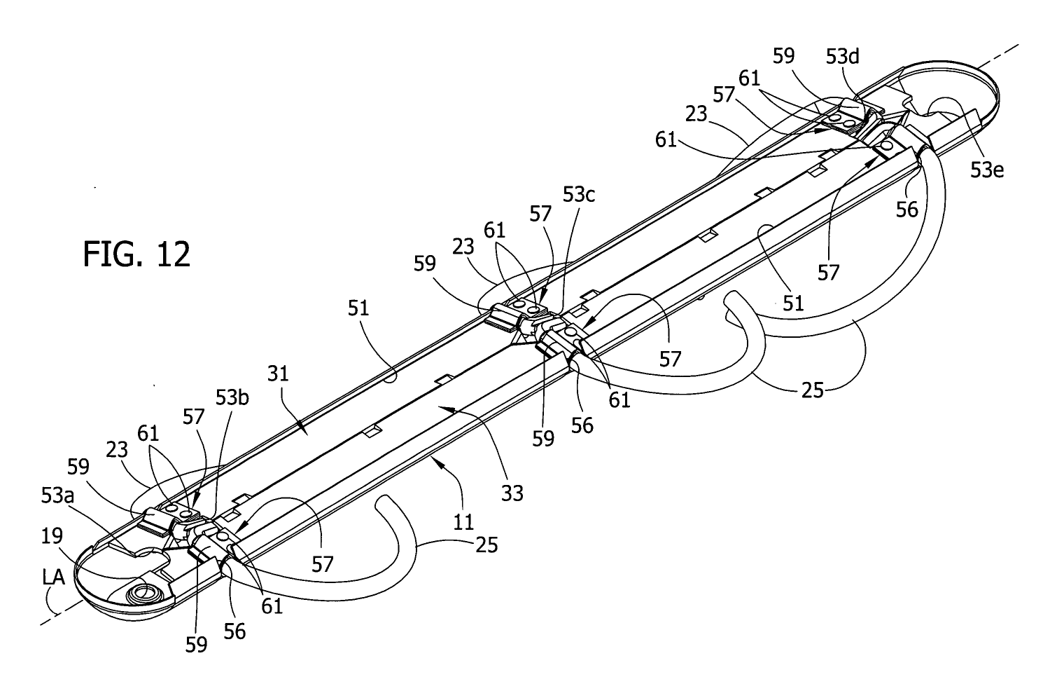

FIGS. 11 and 12 show the ring mechanism 1 in the collapsed configuration. Ring members 23, 25 of the two end rings 13 are pivoted inward, toward the center ring, while the ring members 23, 25 of the center ring 13 are pivoted outward toward the right ring (as viewed in FIGS. 11 and 12). It should be understood that the ring members 23, 25 of each ring 13 can be returned to the operating configuration by rotating them away from the housing 11 in a direction opposite to that just described for collapsing the ring members 23, 25. It can be seen that in the collapsed configuration the mechanism 1 takes up substantially less space.

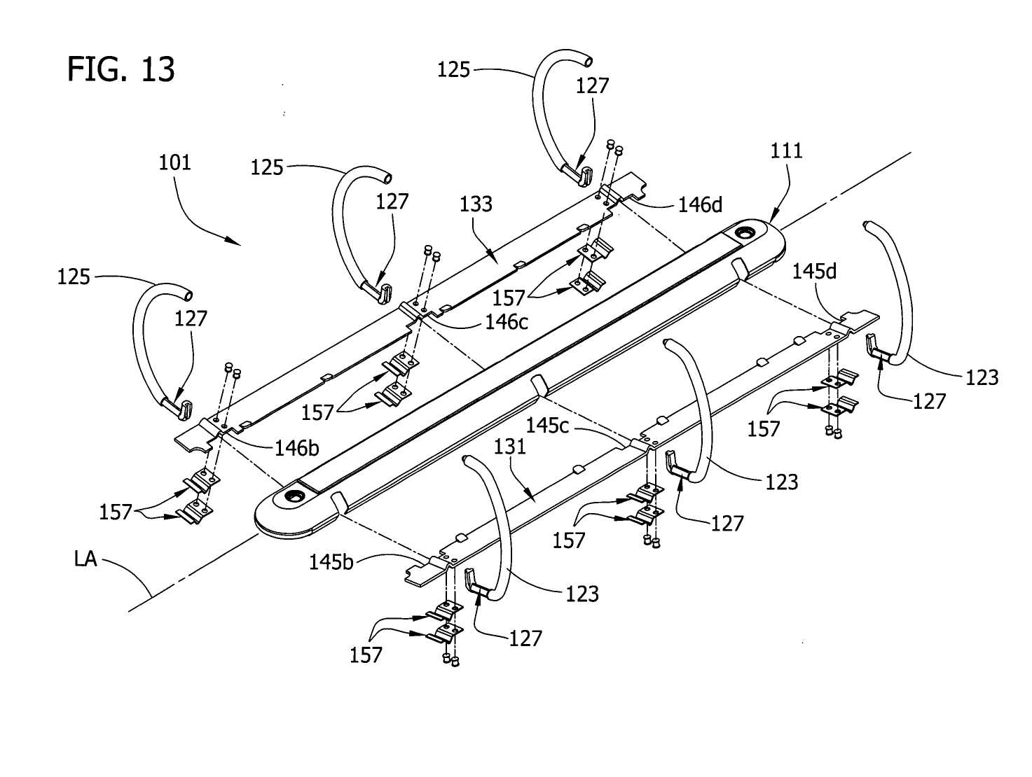

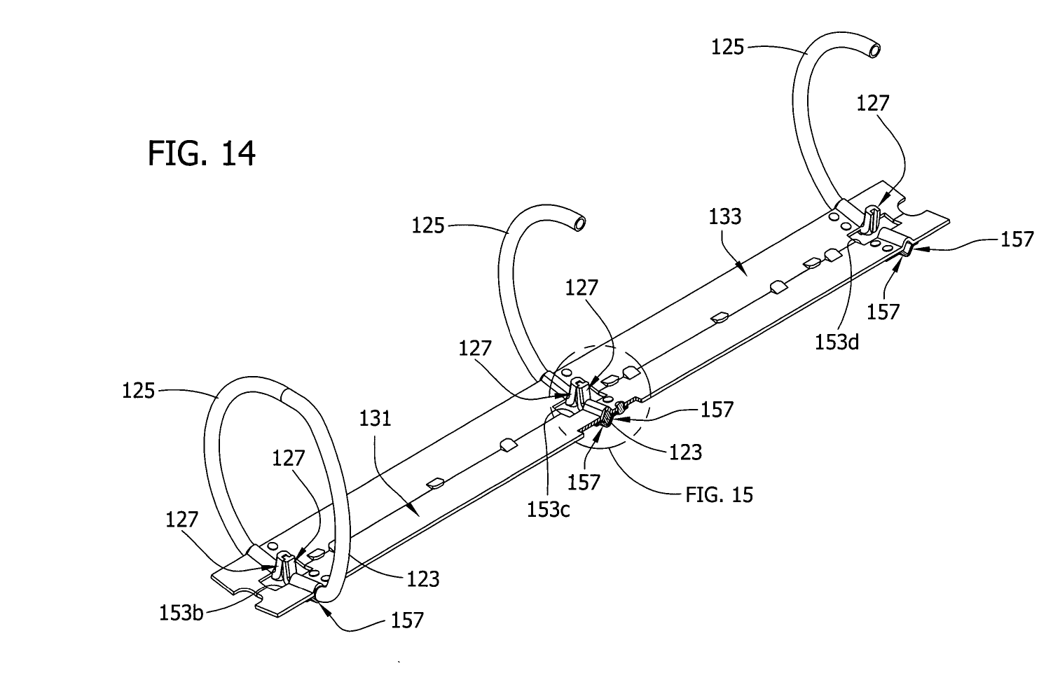

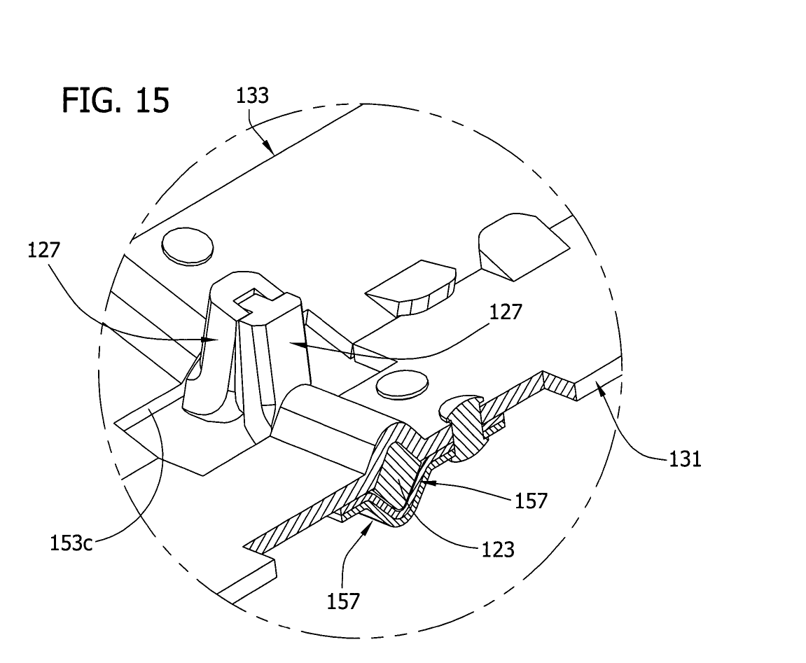

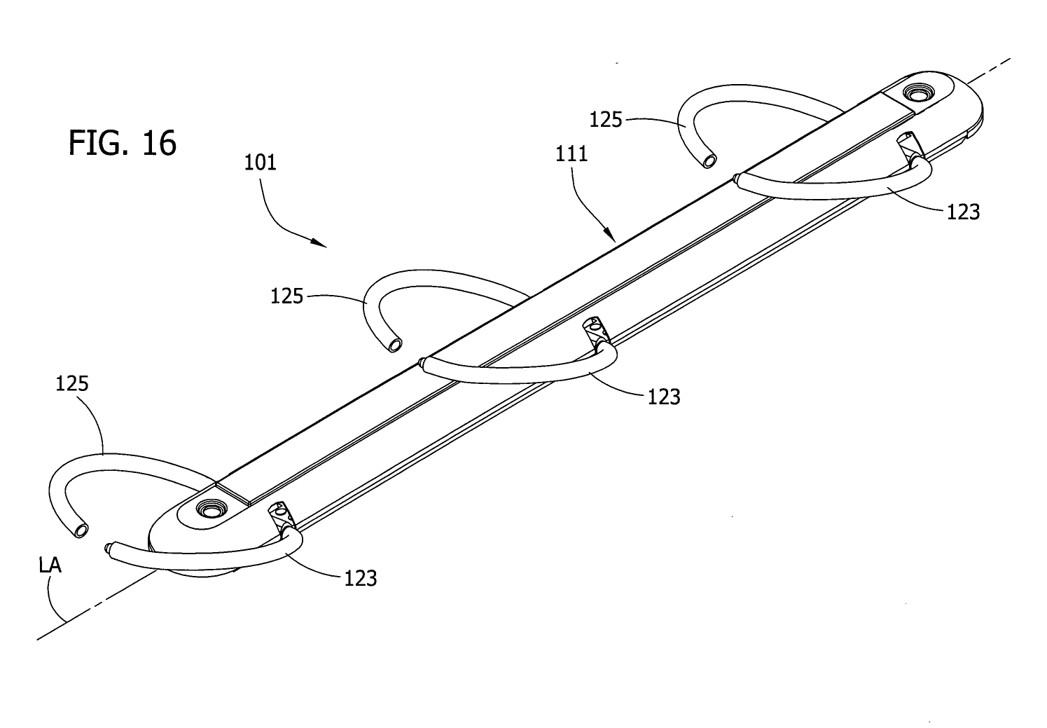

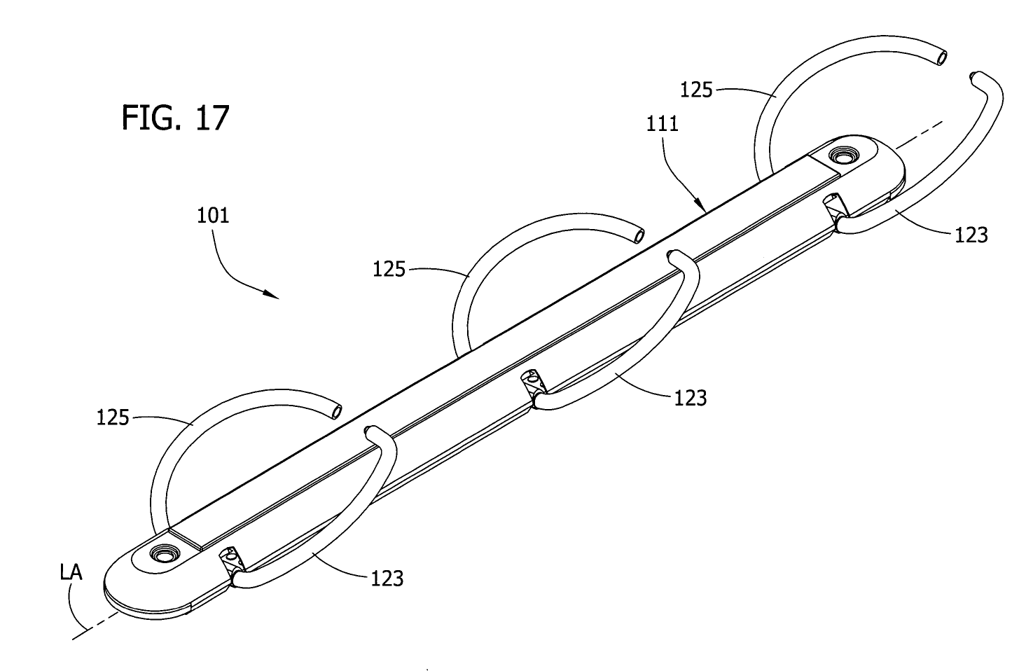

FIGS. 13-17 illustrate a ring binder mechanism according to a second embodiment of the invention. Corresponding parts of the mechanism of the second embodiment will be designated by the same reference numerals as used for the first embodiment, plus “100”. The mechanism is indicated generally by reference numeral 101. The mechanism 101 is substantially the same as mechanism 1 of the first embodiment of FIGS. 1-12 with the exception that hinge plates 131, 133 do not include stoppers at openings 153b-d (FIG. 14) formed by cutouts 145b-d and 146b-d of the plates to limit direction of rotation of ring members 123, 125 when they rotate to the collapsed configuration. As in the first embodiment, L-shaped end segments 127 of ring members 123, 125 of each ring 113 are resiliently clamped against hinge plates 131, 133 by spring mounting plates 157. But in this embodiment, the ring members 123, 125 can move to the collapsed configuration by rotating about an axis perpendicular to the longitudinal axis LA of housing 111 in either a clockwise or counter-clockwise direction (as viewed in the drawings). There are no stoppers resisting rotational direction. In all other aspects, including operation of the ring mechanism 101 to open and close the ring members 123, 125 and to fold the ring members between the operating and collapsed configurations, ring mechanism 101 is the same as ring mechanism 1 of the first embodiment of FIGS. 1-12.

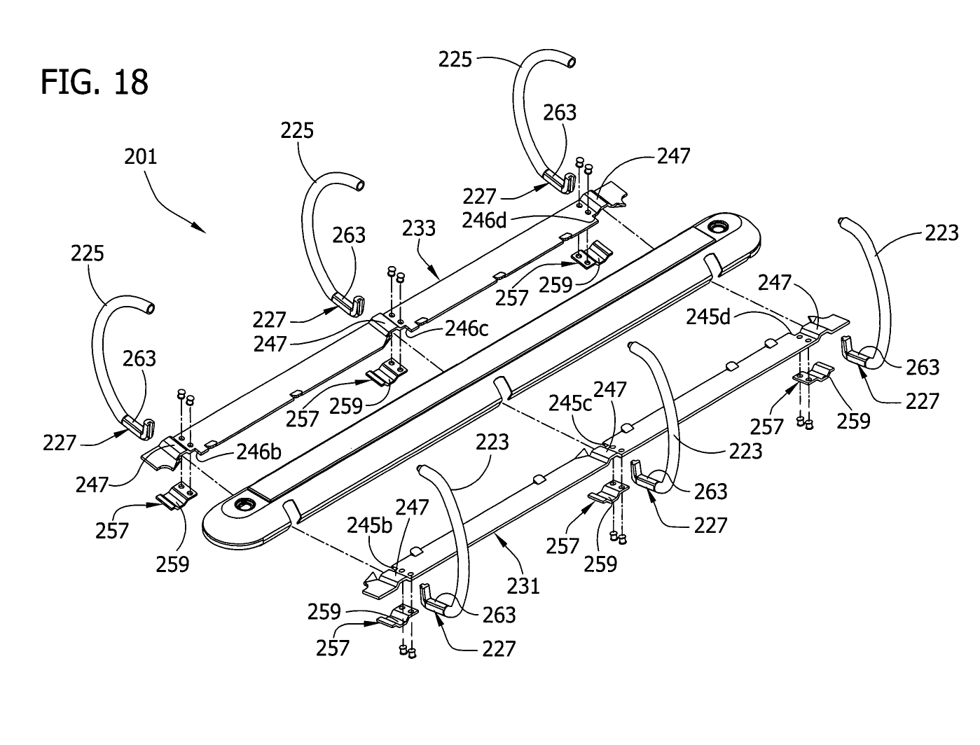

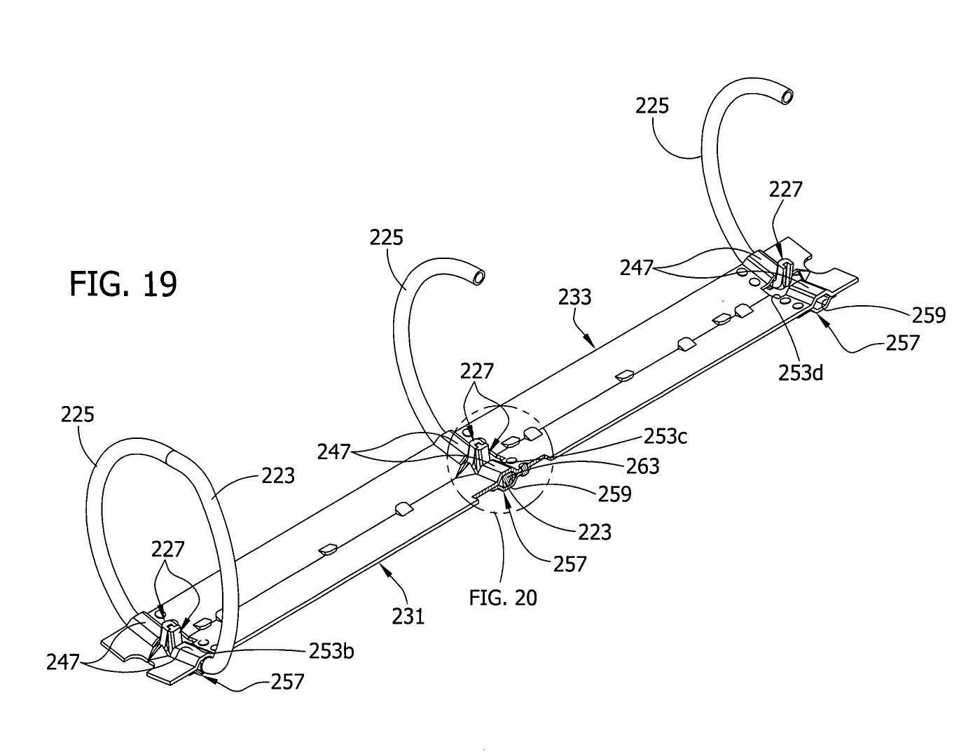

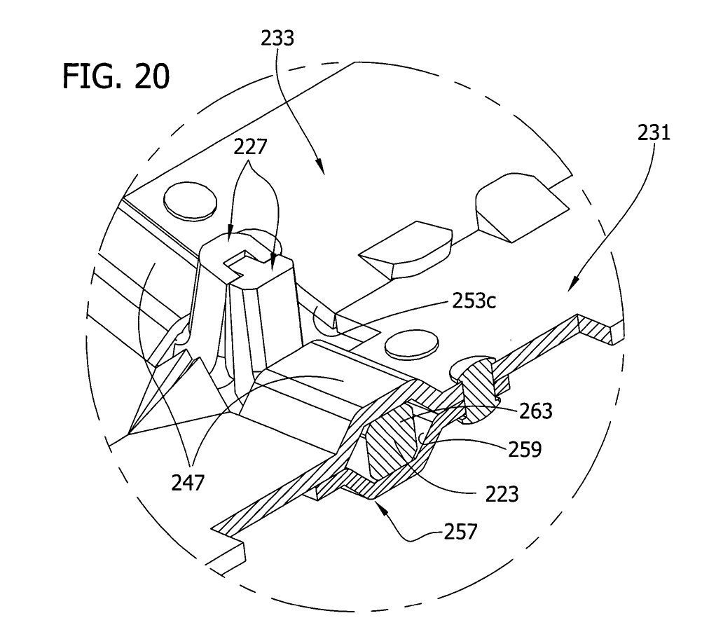

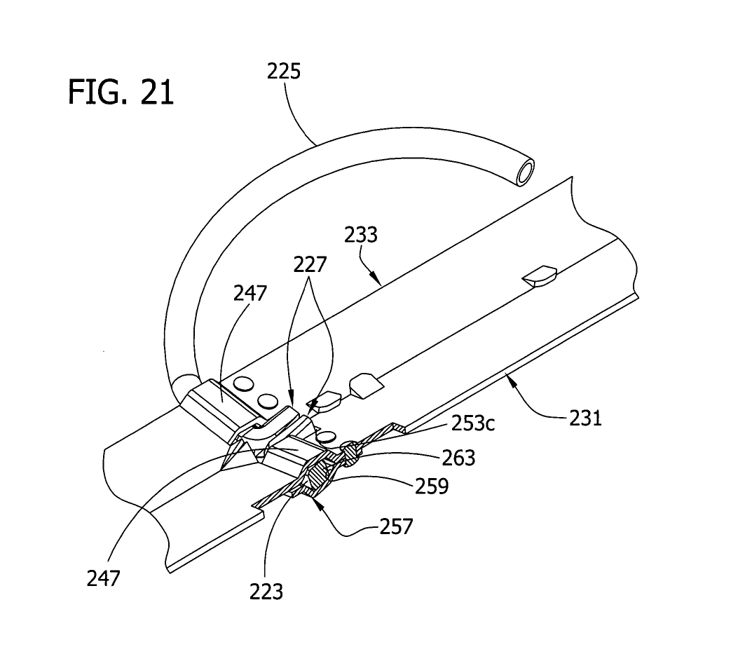

FIGS. 18-21 illustrate a ring binder mechanism according to a third embodiment of the invention. The same reference numerals will be used to designate parts of the mechanism of the third embodiment as used for the first embodiment, plus “200”. The mechanism is indicated generally by reference numeral 201 and is again substantially the same as the ring binder mechanism 1 of the first embodiment of FIGS. 1-12. In this embodiment, however, only one spring mounting plate 257 is used to hold each ring member 223, 225 against respective hinge plates 231 and 233 at openings 253b-d formed by hinge plate cutouts 245b-d and 246b-d. Also in this embodiment, portions 263 of L-shaped end segments 227 of the ring members 223, 225 are square-shaped, not diamond-shaped. To accommodate the square-shaped portions 263, inverted channels 247 of the hinge plates 231, 233 and channels 259 of the mounting plates 257 have flat bottoms. A passage formed between the pairs of channels 247 and 259 when the mounting plates 257 connect to the hinge plates 231, 233 is generally square shaped (FIGS. 19 and 20) with opposed flats for engagement by corresponding flat sides of the square-shaped portions 263. The square-shaped passages receive the square-shaped portions 263 of the ring members 23, 25 in close fit (shape-wise). In all other regards, including operation, mechanism 201 is identical to mechanism 1 of the first embodiment of FIGS. 1-12.

Components of ring binder mechanisms of the different embodiments of the invention are made of a suitable rigid material, such as a metal (e.g. steel). But mechanisms having components made of a nonmetallic material, specifically including a plastic, do not depart from the scope of this invention.

It should be understood that a ring binder mechanism can have ring members with L-shaped end segments that have other than square-shaped cross sections or diamond-shaped cross sections. For example, the L-shaped end segments could have any polygonal-shaped cross section within the scope of this invention. Also, passages formed by inverted channels of hinge plates and channels of spring mounting plates could have any polygonal-shaped cross section matching the polygonal cross section of the L-shaped end segments for receiving the end segments within the scope of this invention.

When introducing elements of the invention according to the several embodiments, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations of these terms is made for convenience, but does not require any particular orientation of the components. Furthermore, “bottom” and “top” as used herein are not meant to limit the scope of the invention. They are relative terms used to indicate relationship of parts within the ring mechanism. Top is generally used to refer to a location of a structural component generally facing the housing. While bottom generally refers to a location generally facing away from the housing.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism for retaining loose-leaf pages, the mechanism comprising:
a housing having a longitudinal axis;
hinge plates supported by the housing for pivoting motion relative to the housing;
rings for holding loose-leaf pages, each ring including a first ring member and a second ring member, the first ring member being moveable with the pivoting motion of a first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings, and
the first ring member of each ring being resiliently clamped to the first hinge plate, and the first and second ring members of each ring being moveable relative to the hinge plates between an upright configuration and a collapsed configuration.

2. A ring binder mechanism as set forth in claim 1 further comprising a mounting plate resiliently clamping the first ring member in compression against the first hinge plate.

3. A ring binder mechanism as set forth in claim 2 wherein the mounting plate is separate from the first hinge plate and attached thereto.

4. A ring binder mechanism as set forth in claim 2 wherein the first ring member includes an end portion and wherein the mounting plate and first hinge plate define a passage said passage being shaped to receive the end portion of the first ring member and to releasably lock the ring member in its upright configuration.

5. A ring binder mechanism as set forth in claim 4 wherein said passage formed by the mounting plate and hinge plate is shaped to releasably lock the ring member in its collapsed configuration.

6. A ring binder mechanism as set forth in claim 4 wherein the end portion of the first ring member is polygonal in cross section and wherein the receiving passage is polygonal in cross section.

7. A ring binder mechanism as set forth in claim 4 wherein the end portion of the first ring member is one of square shaped and diamond shaped and wherein the receiving passage is one of square shaped and diamond shaped.

8. A ring binder mechanism as set forth in claim 2 wherein there are two stacked mounting plates clamping the first ring member in compression against the first hinge plate.

9. A ring binder mechanism as set forth in claim 1 further comprising a stopper adjacent the first ring member where the first ring member is clamped to the first hinge plate, the stopper blocking movement of the first ring member from the upright configuration to the collapsed configuration in the direction of the stopper.

10. A ring binder mechanism as set forth in claim 1 wherein the first and second ring members of each ring are resiliently clamped to first and second hinge plates, respectively.

11. A ring binder mechanism as set forth in claim 10 further comprising a mounting plate for each of the first and second ring members of each ring, each mounting plate resiliently clamping a respective one of the first and second ring members of each ring to the first and second hinge plates, respectively, each mounting plate being separate from the respective hinge plate and attached thereto and being resiliently moveable relative to the hinge plate to allow the first and second ring members of each ring to move between their upright and collapsed configurations.

12. A ring binder mechanism as set forth in claim 10 wherein the first and second ring members of each ring are operatively connected for conjoint movement between their upright and collapsed configurations.

13. A ring binder mechanism for retaining loose-leaf pages, the mechanism comprising:
a housing having a longitudinal axis;
hinge plates supported by the housing for pivoting motion relative to the housing;
rings for holding loose-leaf pages, each ring including a first ring member and a second ring member, the first ring member being moveable with the pivoting motion of a first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings;
the first and second ring members each having a mated end, the mated end of the first ring member having a tongue and the mated end of the second ring member having a groove for receiving the tongue of the first ring member into operative connection with the groove, the tongue and groove each having a length substantially aligned with the lengths of the first and second ring members.

14. A ring binder mechanism as set forth in claim 13 wherein the tongue and groove of each ring are adapted to rock relative to each other as the first and second ring members move between the open and closed positions.

15. A ring binder mechanism as set forth in claim 13 wherein the mated tongue and groove of each ring lock the first and second ring members of the ring for conjoint rotation relative to the hinge plates about an axis generally perpendicular to the longitudinal axis of the housing between an upright configuration and a collapsed configuration.

16. A ring binder mechanism as set forth in claim 13 wherein the first ring member is resiliently clamped to the first hinge plate and the second ring member is resiliently clamped to a second hinge plate, the tongue of the first ring member extending at an angle that is skew relative to a plane containing the first hinge plate and the groove of the second ring member extending at an angle that is skew to a plane containing the second hinge plate.

17. A ring binder mechanism as set forth in claim 16 wherein the first and second hinge plates define openings, the operatively connected tongue and groove of each ring being located substantially within a respective one of the openings of the hinge plates and being held together within the openings by a spring force of the housing.
